(19) United States
(12) Patent Application Publication
(10) Pub. No.: US 2021/0033176 A1
(43) Pub. Date: Feb. 4, 2021

(54) BUFFER GEAR SET FOR POWER TOOL

(71) Applicant: TRANMAX MACHINERY CO., LTD., Taichung City (TW)

(72) Inventor: HSIN-CHI CHEN, TAICHUNG CITY (TW)

(21) Appl. No.: 16/565,914

(22) Filed: Sep. 10, 2019

(30) Foreign Application Priority Data
Jul. 31, 2019 (TW) 108127246

(51) Int. Cl. F16H 35/10; F16H 3/44; B25B 21/00

(52) U.S. Cl. CPC F16H 35/10; F16H 2200/20; B25B 21/00; F16H 3/44

(57) ABSTRACT

A buffer gear set mounted between a motor and a transmission assembly of a power tool is disclosed to include an outer ring seat and an inner ring seat coaxially arranged together, a planetary gear set mounted in the outer ring seat, accommodation spaces defined between the outer ring seat and the inner ring seat, and buffer members respectively accommodated in the accommodation spaces. When an external force is applied between the outer ring seat and the inner ring seat, the buffer members absorb a part of the external force transmitted between the outer ring seat and the inner ring seat, thereby reducing the impact of the overall power tool, achieving shock absorption, reducing noise and improving work efficiency and quality.

### BACKGROUND OF THE INVENTION

### 1. Field of the Invention

The present invention relates to power tool technology, and more particularly to a buffer gear set for power tool.

### 2. Description of the Related Art

Power tools are configured for a variety of tightening or loosening operations using a rotating shaft. In addition to being generally a simple screwdriver, some power tools can also generate impact force to increase the rotational torque, so as to enhance the effect of tightening and disassembling components.

However, a power tool will continue to produce a reaction force to the user during operation, often accompanied by noise or vibration to make the user feel uncomfortable. Long-term work can easily affect work efficiency and work quality.

### SUMMARY OF THE INVENTION

The present invention has been accomplished under the circumstances in view. It is the main object of the present invention to provide a buffer gear set for power tool, which can reduce the impact of the overall power tool, thereby achieving shock absorption, reducing noise and improving work efficiency and quality.

To achieve this and other objects of the present invention, a buffer gear set is used in a power tool comprising a motor and a transmission assembly. The buffer gear set is located between the motor and the transmission assembly, comprising an outer ring seat and an inner ring seat coaxially mounted in the outer ring seat. The outer ring seat is set at the motor. The inner ring seat has a planetary gear set mounted therein. The outer ring seat and the inner ring seat define therebetween at least one accommodation space. The at least one accommodation space has at least one buffer member accommodated therein. When an external force is applied between the outer ring seat and the inner ring seat, the at least one buffer member absorbs a part of the external force transmitted between the outer ring seat and the inner ring seat, thereby reducing the impact of the overall power tool, achieving shock absorption, reducing noise and improving work efficiency and quality.

Preferably, the least one accommodation space is arranged along the radial direction of the outer ring seat at a position adjacent to the inner ring seat and the inner ring seat.

Preferably, the outer ring seat comprises at least one positioning portion, the inner ring seat comprises at least one fixing portion, and the at least one accommodation space is formed between the at least one positioning portion and the at least one fixing portion.

Other and further benefits, advantages and features of the present invention will be understood by reference to the following specification in conjunction with the accompanying drawings, in which like reference characters denote like elements of structure.

### BRIEF DESCRIPTION OF THE DRAWINGS

FIG. 1 is an oblique elevational view of a power tool equipped with a buffer gear set in accordance with the present invention.

FIG. 2 is an exploded view of the power tool shown in FIG. 1.

FIG. 3 is a sectional elevation of the power tool shown in FIG. 1.

FIG. 4 is a sectional view taken along line 4-4 of FIG. 1.

### DETAILED DESCRIPTION OF THE INVENTION

The technical content and features of the present invention will be described in detail below by referring to the preferred embodiment and the annexed drawings. The invention can be widely applied to various forms or specifications of power tools Those skilled in the art can understand that the description of the present preferred embodiment belongs to the generic description of the application field. For example, a material or shape term includes and is not limited to the material or shape specified by the description, and the positional terms include and are not limited to setting, approaching, connecting, or abutting. The number of elements “one” includes one and more than one number of complex components. The directional expressions such as “upper”, “lower”, “inside”, “outside”, “top” and “bottom” mentioned in the contents of this specification are merely illustrative terms used in the normal direction of use, not intended to limit the scope of the claim.

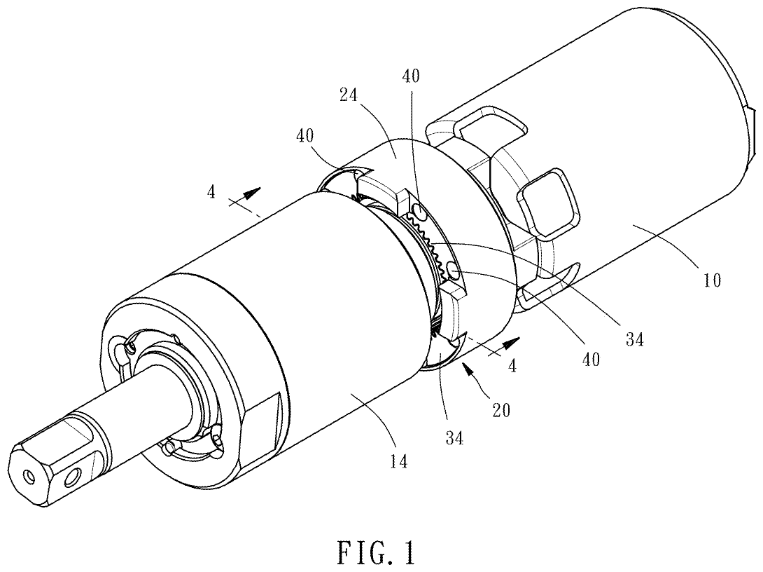

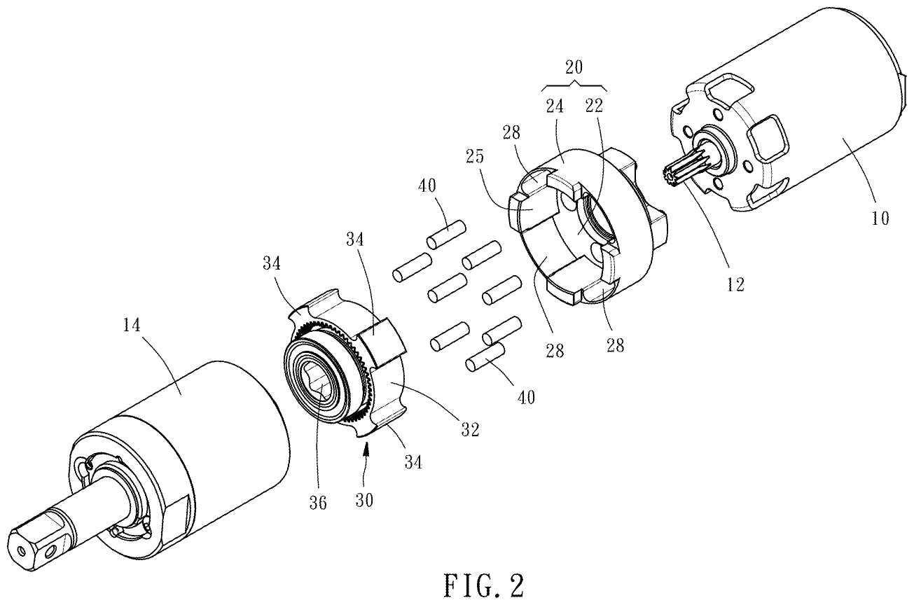

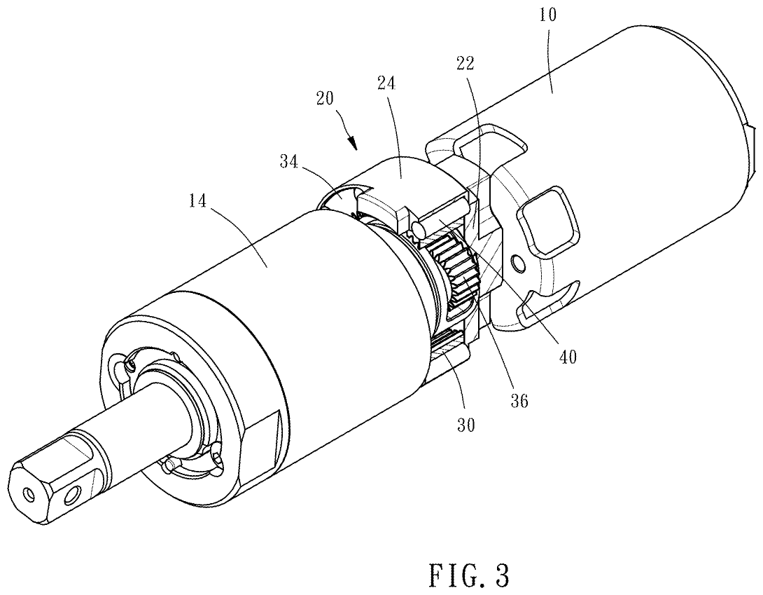

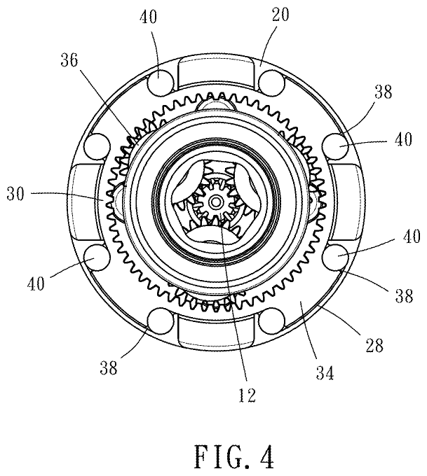

Referring to FIGS. 1-4, the invention provides a buffer gear set for use in a power tool comprising a motor 10 and a transmission assembly 14. The buffer gear set is located between the motor 10 and the transmission assembly 14. Transmission assembly 14 can be an impact type impacting device set or a non-impact type of rotating assembly.

The buffer gear set comprises an outer ring seat 20 having a base portion 22 and an outer peripheral wall 24 disposed on the base portion 22. The inner surface 25 of the outer peripheral wall 24 is provided with at least one positioning portion 28. In the present preferred embodiment, the at least one positioning portion 28 is exemplified by four grooves recessed in the inner surface 25 of the outer peripheral wall 24.

The buffer gear set further comprises an inner ring set 30 coaxially mounted in the outer ring seat 20. The outer peripheral surface 32 of the inner ring seat 30 is provided with at least one fixing portion 34. The at least one fixing portion 34 of the preferred embodiment is exemplified by four convex portions protruding from the outer peripheral surface 32.

The inner circumference of the inner ring seat 30 is toothed and coupled to a planetary gear set 36 and is coupled to the output shaft 12 of the motor 10 and the transmission assembly 14 through the planetary gear set 36.

Each of the positioning portions 28 of the outer ring seat 20 and the respective fixing portions 34 of the inner ring seat 30 are fitted to each other. Since the width of the positioning portion 28 is larger than the width of the fixing portion 34, the positioning portion 28 of the outer ring seat 20 forms an accommodation space 38 on both sides of the fixing portion 34 of the inner ring seat 30 in which the buffer member 40 can be disposed.

The accommodation spaces 38 are located at circumferential positions adjacent to the outer ring seat 20 and the inner ring seat 30 and are equally spaced from one another along the radial direction of the outer ring seat 20. The buffer members 40 are disposed between the outer ring seat 20 and the inner ring seat 30. The buffer members 40 of the preferred embodiment are exemplified by a cylinder made of an elastic material such as rubber or the like. When an external force is applied between the outer ring seat 20 and the inner ring seat 30, each buffer member 40 can absorb some of the external force transmitted between the outer ring seat 20 and the inner ring seat 30.

With the above-described constituent members of the present invention, the output shaft 12 of the motor 10 directly drives the planetary gear set 36 to drive the transmission assembly 14, thereby generating rotation and impact. When the impact force is generated and the feedback is transmitted to the planetary gear set 36 and the inner ring seat 30, the buffer members 40 can absorb and reduce part of the impact force and then pass to the outer ring seat 20, further reducing the impact of the motor 10 and the overall power tool, thus, the invention achieves shock absorption, reduces noise and improves work efficiency and quality.

What is claimed is:

1. A buffer gear set used in a power tool comprising a motor and a transmission assembly, said buffer gear set being located between said motor and said transmission assembly, said buffer gear set comprising an outer ring seat and an inner ring seat coaxially mounted in said outer ring seat, said outer ring seat being set at said motor, said inner ring seat having a planetary gear set mounted therein, said outer ring seat and said inner ring seat defining therebetween at least one accommodation space, said at least one accommodation space having at least one buffer member accommodated therein such that when an external force is applied between said outer ring seat and said inner ring seat, said at least one buffer member absorbs a part of the external force transmitted between said outer ring seat and said inner ring seat.

2. The buffer gear set for power tool as claimed in claim 1, wherein said at least one accommodation space is arranged along the radial direction of said outer ring seat at a position adjacent to said inner ring seat and said inner ring seat.

3. The buffer gear set for power tool as claimed in claim 1, wherein said outer ring seat comprises at least one positioning portion; said inner ring seat comprises at least one fixing portion; said at least one accommodation space is formed between said at least one positioning portion and said at least one fixing portion.
